(19) United States
(12) Patent Application Publication
(10) Pub. No.: US 2010/0048163 A1
(43) Pub. Date: Feb. 25, 2010

(54) MOBILE DEVICE LOCATION SYSTEM FOR WIRELESS E911 SERVICES

(76) Inventors: Mark H. Parr, Hillsborough, NJ (US); Arthur A. Julius, Chatham, NJ (US)

Correspondence Address: Nixon Peabody LLP, P.O. Box 60610, Palo Alto, CA, 94306, US

(21) Appl. No.: 12/194,719

(22) Filed: Aug. 20, 2008

(51) Int. Cl. H04M 11/04; H04W 24/00; H04W 4/02; H04M 1/00

(52) U.S. Cl. 455/404.2; 455/404.1; 455/456.1; 455/562.1

(57) ABSTRACT

Disclosed are systems and methods for locating a mobile telecommunication device within a building or underground facility. The system operates by receiving over a telecommunication network an emergency transmission from a mobile telecommunication device located within the facility. The system then determines propagation time delay of the received emergency transmission and identifies two or more RF nodes located within the facility in the proximity of the mobile device based on the determined propagation time delay. The system then sends a request to the identified RF nodes to perform signal strength measurements on the mobile telecommunication device. The system then compares the signal strength measurements of the RF nodes to estimate the approximate location coordinates of the mobile telecommunication device relative to the RF nodes within the facility.

### TECHNICAL FIELD

The present disclosure relates generally to the field of wireless communications and, more specifically, to an enhancement of wireless E911 location technology in the indoors or underground environments.

### BACKGROUND

Wireless phones and other mobile telecommunication devices are often used to call 911 to report traffic accidents, crimes or other emergencies. Prompt delivery of these and other wireless 911 calls to public safety organizations benefits the public by promoting safety of life and property. Because wireless phones are mobile, they are not associated with one fixed location or address. A caller using a wireless phone could be calling from anywhere. While the location of the cell site closest to the caller may provide a very general indication of the caller's location, that information is not usually specific enough for rescue personnel to deliver assistance to the caller quickly.

To address this problem, the Federal Communications Commission (FCC) has advanced a Wireless Enhanced 911 (E911) location technology. Wireless E911 allows mobile, or cellular, phones to process 911 emergency calls and enables emergency services to locate the geographic position of the caller in order to provide the necessary assistance. Wireless E911 requires that each mobile phone company doing business in the United States offers handset- or network-based location detection capability, so that the caller's location is determined by the geographic location of the cellular phone.

In response, the telecommunication industry has developed a number of solutions for locating a mobile devices. Some location technologies, such as angle of arrival (AOA) and time difference of arrival (TDOA), involve triangulation between radio towers. The location signature method uses “fingerprinting” to store and recall patterns (such as multipath) which mobile phone signals are known to exhibit at different locations in each cell. Other handset-based radiolocation technologies rely on Global Postitioning System (GPS) to identify the location of the mobile device. There are also a number of hybrid solutions, which use both the handset- and network-based technologies.

These and other known wireless E911 location technologies often fail to provide exact location of mobile devices in building or underground subway stations, where radio signal strength may be too week due to reflections, diffractions, and attenuated passage through internal walls, floors, ceilings or may be absent altogether due to the absence of radio towers. Accordingly, there is a need for an enhancement of wireless E911 location technology in the in-doors or underground environments.

### Overview

Disclosed are systems and methods for locating a mobile telecommunication device within a building or underground facility. In one example embodiment, the system includes one or more RF nodes located in the facility. Each RF node may have one or more RF antennas distributed within the facility. The RF node is configured to receive an emergency wireless transmission from a mobile telecommunication device located within the facility. The system further includes a remote data processing node connected to the one or more RF nodes via a wired telecommunication network, such as a fiber-optic network or the like.

In one example embodiment, the processing node receives an emergency transmission from the RF node. The processing node determines propagation time delay of the emergency transmission over the wired telecommunication network and identifies two or more RF nodes proximate to the mobile device based on the time delay data. The processing node then instructs the identified RF nodes to perform signal strength measurements on the mobile device. The processing node then determined location of the mobile telecommunication device within the facility based on the signal strength measurements of the RF nodes. Once location of the mobile device is determined, the emergency call is routed to the nearest public safety answering point (PSAP).

Other embodiments will be described in the detailed description below.

### BRIEF DESCRIPTION OF DRAWINGS

The invention may be best understood by referring to the following description and accompanying drawings that are used to illustrate embodiments of the invention.

In the drawings:

FIG. 1 illustrates one example embodiment of a system for locating mobile telecommunication devices in the indoors or underground environments;

FIG. 2 illustrates another example embodiment of a system for locating mobile telecommunication devices in the indoors or underground environments; and

FIG. 3 illustrates one example embodiment of a process for locating mobile telecommunication devices in the indoors or underground environments.

### DETAILED DESCRIPTION OF EXAMPLE EMBODIMENTS

Those of ordinary skill in the art will realize that the following detailed description of the present invention is illustrative only and is not intended to be in any way limiting Other embodiments of the present invention will readily suggest themselves to such skilled persons having the benefit of this disclosure. It will be apparent to one skilled in the art that these specific details may not be required to practice the present invention. In other instances, well-known computing systems, communication networks and various data collection devices are shown in block diagram form to avoid obscuring the present invention. In the following description of the embodiments, substantially the same parts are denoted by the same reference numerals.

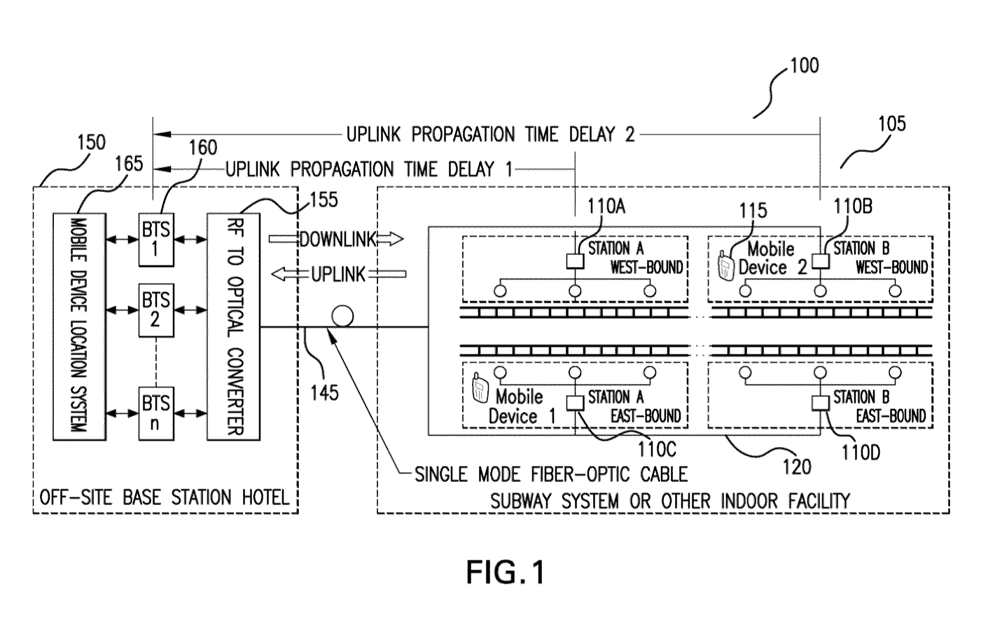

FIG. 1 illustrates one example embodiment of a system for processing wireless E911 calls from mobile telecommunication device located in the indoors or underground facility. In general, a system 100 includes one or more RF nodes 110 installed in the indoors or underground facility 105 and an off-site base station hotel (“BST”) 150. RF nodes 110 serve as an extension of the wireless/cellular network in the indoor environment. In particular, RF nodes 110 are configured to detect wireless E911 calls initiated by mobile devices 115 and to route these calls via a wired network 120 to the off-site BST 150. BST 150 processes the received E911 calls to determine location of the mobile device 115 and forwards the E911 calls to the selected public safety answering point (“PSAP”), which in turn sends emergency services to the caller's location.

In one example embodiment, a RF node 110 may include one or more RF antennas 125 distributed within the facility to facilitate reception of RF signals from mobile devices 115. The antennas 125 are coupled to one or more wireless access point devices (not shown), which relay data between the wireless mobile devices 115 and wired network 120. In the embodiment where the wired network 120 includes a fiber-optic network, the RF node 110 converts RF energy into laser-light energy in the uplink direction and laser-light energy into RF energy in the downlink direction. In addition, the RF node 110 may include a separate location radio (“LR”) receiver for monitoring uplink RF channels to measure signal strengths of mobile devices requesting 911 connections.

In one example embodiment, RF node 110 may support one or more wireless communication standards including, but is not limited to, a Wireless Local Area Network (WLAN) standard that utilizes Ethernet (IEEE 802.3), IEEE 802.11, or other current or future LAN standards; Wireless Wide Area Network (WWAN) standard that utilize 3GPP (e.g. GSM, EDGE, UMTS, HSDPA, LTE), 3GPP2 (e.g. CDMA, EVDO) or other current or future WWAN standards, Wireless Metropolitan Area Network (WMAN) standard that utilize WiMAX (IEEE 802.16) or other current or future WMAN systems, Wireless Personal Area Network (WPAN) that utilize IEEE 802.15 or Bluetooth. Other wireless and/or cellular networking technologies known to those of ordinary skill in the art may be used in alternative embodiment of the invention.

In one example embodiment, there may be a plurality of RF nodes 110 strategically placed through out the underground facility 105 to provide wireless network coverage of the entire facility 105 and to assure that mobile devices 115 are within reach of at least two RF nodes 110 at any given time. For example, the underground subway system 105 may have one or more RF nodes 110 at each of Station A and Station B. As such, mobile device 1 is within coverage of at least RF node 110A located at Station A, west-bound platform, and RF node 110C located at the Station A, east-bound platform; and mobile device 2 is within coverage of at least RF node 110B located at Station B, west-bound platform, and RF nodes 110D located at Station B, east-bound platform. Furthermore, each RF node 110 may be connected to several omni-directional antennas 125 to ensure homogeneous transmission and reception of RF energy along the platform.

In one example embodiment, the indoors or underground facility 105 may be wired with a fiber-optic network 120, which may include a single-mode low-loss fiber-optic cable capable of transmitting optical signal over large distances, e.g., 10 kilometers and more. The network may if necessary include a plurality of signal repeaters, routers, switches and other networking devices. The method of data transmission over the fiber-optic network 120 may include, but is not limited to Ethernet, gigabit Ethernet, Asynchronous Transfer Mode (“ATM”), Synchronous Digital Hierarchy (“SONET”), Synchronous Digital Hierarchy (“SDH”), Plesiochronous Digital Hierarchy (PDH) or other known technologies. In alternative embodiments, the wired network 120 may include an Ethernet over twisted pair, such as 10 BASE-T, 100 BASE-TX, and 1000 BASE-T network, or coaxial-cable based T1, T2, T3, T4 or T5 network. Other networking technologies known to those of ordinary skill in the art may be used in alternative embodiments of the invention.

In one example embodiment, the system 100 further includes a base station hotel (“BSH”) 150. BSH facility is usually located on the ground and houses radio base station equipment. This equipment may include a plurality of base transceiver stations (“BTS”) 160. BTS equipment may be installed on rooftops and towers and may be owned by Wireless Service Providers (“WSP”). BTS 160 enable RF linking to various mobile devices. BSH 150 may distribute signal into the subway system 105 via a fiber-optic network 120 using RF to optical converter 155, which is a multiplexing device that combines all RF signals from resident BTS equipment in the downlink direction: resultant combined RF signal is then directly converted to laser-light energy suitable for transmission over fiber-optic facilities 120. It also converts laser-light energy in the uplink direction to RF energy and distributes it to BTS 160 equipment.

Generally, the plurality of base transceiver stations (“BTS”) 160 constitute a part of a cellular communication network for connection with the cellular telephones, such as those located within the mobile device 115. Generally, BTS 160 are connected to the cellular infrastructure network that provides communication services with a plurality of other communication networks such as the public switched telephone network (“PSTN”) and other cellular and wireless communication networks. For example, the cellular infrastructure network provides communication that allows the mobile devices 115 to communicate with PSAPs using the BTS 160 and the PSTN.

In one example embodiment, BTS 160 may support one or more wireless communication standards including, but is not limited to, a Wireless Local Area Network (WLAN) standard that utilizes Ethernet (IEEE 802.3), IEEE 802.11, or other current or future LAN standards; Wireless Wide Area Network (WWAN) standard that utilize 3GPP (e.g. GSM, EDGE, UMTS, HSDPA, LTE), 3GPP2 (e.g. CDMA, EVDO) or other current or future WWAN standards, Wireless Metropolitan Area Network (WMAN) standard that utilize WiMAX (IEEE 802.16) or other current or future WMAN systems, Wireless Personal Area Network (WPAN) that utilize IEEE 802.15 or Bluetooth. Other wireless and/or cellular networking technologies known to those of ordinary skill in the art may be used in alternative embodiment of the invention.

In one example embodiment, BSH 150 includes a mobile device location system (“MLS”) 165. MLS 165 may include a computer server, which includes one or more general processing units and a memory. The processor may include an Intel® Dual-Core™ or Pentium® processor, an AMD Turion™ 64 processor or other types of central processing units (“CPU”). The processor is configured to run one or more applications for performing signal propagation time delay measurements and signal strength-based location computations. The system memory may be used to store critical network parameters, such as various look-up tables described herein. The memory may include a random access memory (RAM), a read only memory (ROM), a programmable ROM (PROM), an erasable PROM (EPROM), a FLASH-EPROM and/or other types of dynamic, volatile and nonvolatile information storage medium. MLS 165 may be connected to the BTS 160 using wired or wireless connection.

In one example embodiment, the MLS 165 is configured to determine location coordinates of the mobile devices 115 requesting a 911 connection. The positioning technique used by the MLS 165 involves two steps. First, MLS 165 identifies two or more RF nodes in the proximity of the mobile device 115 by comparing the actual uplink propagation time delay of the 911 transmission with a look-up table containing information on various facilities containing RF nodes and the corresponding uplink signal propagation time delays. For example, the look-up table may be as follows:

| Location | Uplink Propagation Time Delay |
|---|---|
| Station A | Uplink propagation time delay 1 = 33 μs |
| Station B | Uplink propagation time delay 2 = 43 μs |

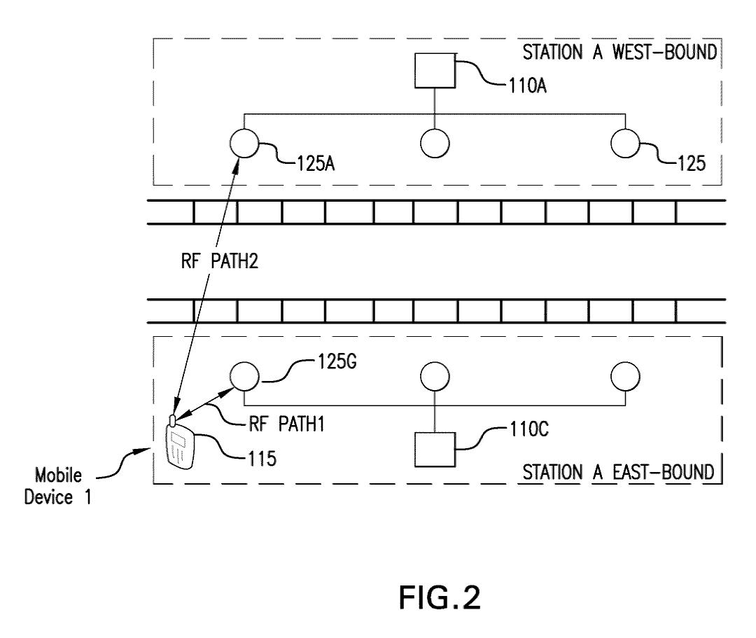

Once the approximate location of the mobile device 115 is determined, the MLS 165 proceeds to the second step, which involves requesting all RF nodes at the identified location to perform signal strength measurements on the mobile device 115 using, build-in location radios (“LR”). FIG. 2 illustrates one example of this procedure. The positioning technique requires at least two data points to locate a mobile device 115 with more data points providing better signal resolution. The signal strength measurement data is returned to MLS 165, which performs “triangulation” by comparing all signal measurements to determine exact position of the mobile device 115 relative to the RF nodes 110, whose positions are known. With reference to FIG. 2, the signal of mobile device 115 measured at antenna 125A of RF node 110A is weaker than the signal measured at antenna 125C of RF node 110C; therefore, the mobile device 115 must be located on Station A, east-bound platform and not on the west-bound platform.

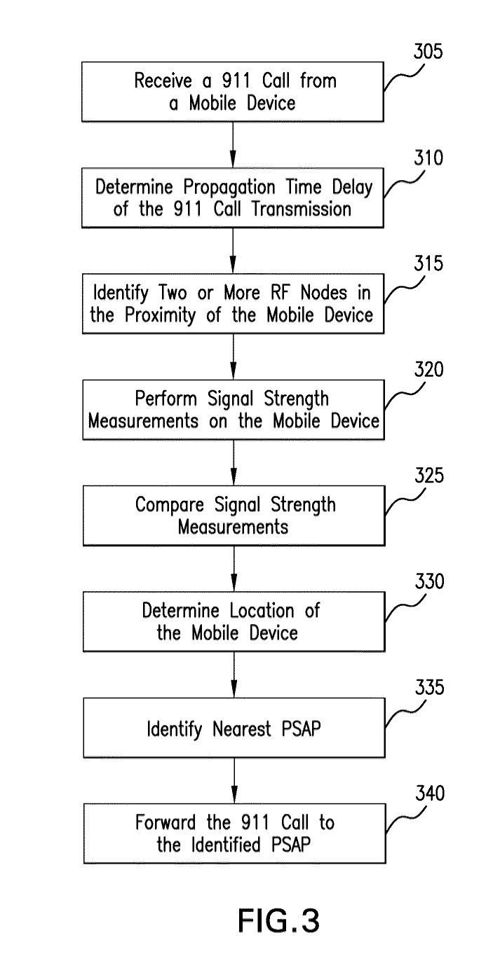

One example embodiment of a process for locating a mobile telecommunication device within a building or underground facility will be described next with references to FIGS. 1, 2 and 3. At step 305, an underground RF node receives a 911 call transmission from a mobile device located at Station A, east-bound platform. The RF node forwards the 911 call transmission via a fiber-optic network to the MLS 165. At step 310, MLS 165 measures the uplink propagation time delay incurred by the signal as it travels through the wired network 120. This delay (i.e., uplink propagation time delay 1) may be compared to a table of known delays within the MLS database to determine that the mobile device 110 is located within the confines of Station A.

At step 315, MLS 165 sends a request to all location radios (“LR”) located at Station A to perform an uplink signal strength measurement on mobile device 165. In this particular example, there are two RF nodes at Station A (FIG. 2) with each containing one embedded LR. At step 320, signal strength measurements from RF Path 1 and RF Path 2 are taken by both LR's and reported back to the MLS 165. At step 325, the MLS 165 compares the signal strength measurements. Since the signal strength reported by the east-bound platform LR is greater than that reported by the west-bound platform LR, the MLS concludes at step 330 that mobile device 115 requesting a 911 connection is located on the east-bound platform of Station A.

At step 335, the MLS 165 identified a Public Safety Answering Point (“PSAP”) servicing the that location and forwards the 911 call along with location coordinates of the mobile device 115 to the PSAP, step 340. The PSAP can then deliver both the number and the location coordinates to the appropriate emergency service (fire, police and ambulance), so that the emergency response unit can proceed to the appropriate location.

In accordance with this disclosure, the components, process steps, and/or data structures described herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Alternatively, the processes disclosed herein may be embodied in machine-executable instructions, which may be used to cause a general-purpose or special-purpose processor or logic circuits programmed with the instructions to perform the operations. Embodiments of the invention may be provided as a computer program product that may include a machine-readable medium having stored thereon instructions, which may be used to program a computer (or other electronic devices) to perform processes disclosed herein. The machine-readable medium may include, but is not limited to, optical and magneto-optical disks, ROMs, RAMs, EPROMs, EEPROMs or other type of medium for storing electronic instructions.

In the interest of clarity, not all of the features of the implementations described herein are shown and described. It will, of course, be appreciated that in the development of any such actual implementation, numerous implementation-specific devices must be made in order to achieve the developer's specific goals, wherein these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In addition, those skilled in the art will recognize that the invention is not limited to the embodiments described, but can be practiced with modification and alteration within the spirit and scope of the appended claims. The description is thus to be regarded as illustrative instead of limiting.

What we claim is:

1. A method for locating a mobile telecommunication device within a building or underground facility, the method comprising:
receiving over a telecommunication network an emergency transmission from a mobile telecommunication device located within the facility;
determining propagation time delay of the received emergency transmission;
based on the determined propagation time delay, identifying two or more RF nodes located within the facility in the proximity of the mobile device;
sending a request to the identified RF nodes to perform signal strength measurements on the mobile telecommunication device; and
comparing the signal strength measurements of the RF nodes to estimate the approximate location coordinates of the mobile telecommunication device relative to the RF nodes within the facility.

2. The method of claim 1 further comprising reporting the location coordinates of the mobile telecommunication device to the nearest public safety office.

3. The method of claim 1, wherein the emergency transmission includes a 911 call.

4. The method of claim 1, wherein detecting an emergency transmission from a mobile telecommunication device includes detecting activity on the designated emergency wireless channel at a RF node.

5. The method of claim 1, wherein the telecommunication network includes at least one of a wireless network segment and at least one wired network segment.

6. The method of claim 5, where in the propagation time delay is computed over the one or more wired network segments.

7. The method of claim 1 further comprising using a look-up table of the RF nodes and the corresponding propagation time delays between each RF node and a remote data processing node to identifying two or more RF nodes located in the proximity of the mobile telecommunication device.

8. A system for locating a mobile telecommunication device in a building or underground facility, the system comprising:
one or more RF nodes located within the facility, each RF node having one or more RF antennas distributed within the facility, wherein a RF node is configured to receive an emergency wireless transmission from a mobile telecommunication device located within the facility, and
a remote data processing node connected to the one or more RF nodes via a wired telecommunication network, the data processing node being configured to
(i) receive from a RF node the emergency transmission from a mobile telecommunication device, and
(ii) determine location of the mobile telecommunication device within the facility based on the propagation time delay of the emergency transmission over the wired telecommunication network and signal strength measurements of two or more RF nodes located in the proximity of the mobile device.

9. The system of claim 8, wherein the data processing node is further configured to report the location coordinates of the mobile telecommunication device to the nearest public safety office.

10. The system of claim 8, wherein the emergency wireless transmission includes a 911 call.

11. The system of claim 8, wherein the emergency transmission includes a transmission on a designated emergency wireless channel.

12. The system of claim 8, wherein the wired telecommunication network includes a fiber optic telecommunication network.

13. The system of claim 8, wherein the wireless telecommunication network includes a cellular network.

14. The system of claim 8, wherein the data processing node uses a look-up table of the RF nodes and the corresponding propagation time delays between the RF node and a remote data processing node to identifying two or more RF nodes located in the proximity of the mobile telecommunication device.

15. A method for locating a mobile telecommunication device in a building or underground facility, the method comprising:
providing within the facility one or more RF nodes, each RF node having one or more RF antennas associated therewith, wherein a RF node is configured to receive an emergency wireless transmission from a mobile telecommunication device located within the facility; and
providing a remote data processing node connected to the one or more RF nodes via a wired telecommunication network, the data processing node being configured to
(i) receive from a RF node the emergency transmission from a mobile telecommunication device located within the facility and
(ii) determine location of the mobile telecommunication device within the facility based on the propagation time delay of the emergency transmission over the wired telecommunication network and signal strength measurements of two or more RF nodes located in the proximity of the mobile device.

16. The method of claim 15 wherein the data processing node is configured to report the location coordinates of the mobile telecommunication device to the nearest public safety office.

17. The method of claim 15, wherein the emergency wireless transmission includes a 911 call.

18. The method of claim 15, wherein the emergency wireless transmission includes a transmission on a designated emergency wireless channel.

19. The method of claim 15, wherein the wired telecommunication network includes a fiber optic telecommunication network.

20. The method of claim 15, wherein the wireless telecommunication network includes a cellular network.

21. The method of claim 15, wherein the data processing node uses a look-up table of the RF nodes and the corresponding propagation time delays between the RF node and the data processing node to identifying two or more RF nodes located in the proximity of the mobile telecommunication device.

22. A RF node located in a building or underground facility, the RF node comprising:
one or more RF antennas distributed within the facility;
a first RF receiver coupled to the one or more RF antennas, the first RF transceiver being configured to receive an emergency wireless transmission from a mobile telecommunication device located within the facility;
a second RF receiver coupled to the one or more RF antennas, the second RF transceiver being configured to measure signal strength of the mobile telecommunication device sending the emergency wireless transmission;
a processor configured to convert the wireless transmission into optical signals;
a fiber optic transmitter configured to send the converted optical signals to a remote data processing node over a fiber optic telecommunication network.

23. The base station of claim 22, wherein the emergency wireless transmission includes a 911 call.

24. The base stations of claim 22, wherein the emergency transmission includes a transmission on a designated emergency wireless channel.

25. The base station of claim 22, wherein the wireless telecommunication network includes a cellular network.
